(19) United States
(12) Patent Application Publication
(10) Pub. No.: US 2010/0317784 A1
(43) Pub. Date: Dec. 16, 2010

(54) INORGANIC POWDER-CONTAINING RESIN COMPOSITION, AND A SUBSTRATE HAVING A DIELECTRIC LAYER FORMED THEREON

(76) Inventors: Katsuya Kume, Osaka (JP); Tomohide Banba, Osaka (JP); Makoto Kai, Osaka (JP); Yasushi Buzoujima, Osaka (JP); Itsuhiro Hatanaka, Osaka (JP); Hidenori Suzuki, Osaka (JP); Tatsuya Suzuki, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/445,911

(22) PCT Filed: Sep. 28, 2007
(86) PCT No.: PCT/JP2007/069039

§ 371 Date: Apr. 16, 2009

(30) Foreign Application Priority Data
Oct. 19, 2006 (JP) 2006-285199

(51) Int. Cl. C09D 191/00; C08K 5/10; C08K 5/11

(52) U.S. Cl. 524/313; 156/89.11; 524/306; 524/312

(57) ABSTRACT

An object is to provide an inorganic powder-containing resin composition excellent in an ability to disperse the inorganic powder and excellent in transferability upon formation into a sheet. Another object is to provide an inorganic powder-containing resin composition capable of forming a dielectric layer having highlight transmittance (without bubble defect) and excellent in surface smoothness. The present invention relates to an inorganic powder-containing resin composition comprising A) an inorganic powder, B) a binder resin, C) diglycerin, and D) at least one diglycerin fatty acid ester selected from the group consisting of a diglycerin fatty acid monoester, a diglycerin fatty acid diester, a diglycerin fatty acid triester, and a diglycerin fatty acid tetraester.

### BACKGROUND OF THE INVENTION

1. Field of the Invention

The present invention relates to an inorganic powder-containing resin composition, a film-forming material layer comprising the composition, a transfer sheet, a dielectric layer, a method of producing a substrate having a dielectric layer formed thereon, a substrate having a dielectric layer formed thereon, and a plasma display panel using the substrate having a dielectric layer formed thereon. In particular, the inorganic powder-containing resin composition of the present invention is useful as a material forming a dielectric layer in a plasma display panel.

2. Description of the Related Art

As thin and flat large display in recent years, attention has been paid to a plasma display panel (referred to hereinafter a “PDP”) together with a liquid crystal display. A part of PDP has a structure wherein a dielectric layer consisting of sintered glass is formed on the surface of a glass substrate having an electrode fixed therein.

A method of forming this dielectric layer wherein a paste composition containing glass powder, an acrylate-based resin and a solvent is applied onto a support film to form a film-forming material layer, then the film-forming material layer formed on the support film is transferred onto the surface of a glass substrate having an electrode fixed therein, and the transferred film-forming material layer is calcined to form a dielectric layer on the surface of the glass substrate is disclosed (Patent Documents 1 and 2).

As the dielectric layer-forming resin composition, a composition comprising 100 to 500 parts by weight of dielectric inorganic powder added to 100 parts by weight of a self-adhesive resin having a weight-average molecular weight of 20,000 to 1,000,000 and a glass transition temperature of 15° C. or less obtained by copolymerizing 80 to 100% by weight of C₁ to C₁₂ methacrylate with 0 to 20% by weight of another monomer copolymerizable therewith is disclosed (Patent Documents 3 and 4).

A transfer sheet having at least a base film and a transfer layer arranged in a releasable manner on the base film, wherein the transfer layer comprises at least a glass frit-containing inorganic component and an organic component capable of removal upon calcination and has surface smoothness Ra in the range of 0.4 μm or less, is disclosed (Patent Document 5). It is described therein that the organic component can, if necessary, contain a transferability-conferring agent such as ortho-phosphates etc. and a dispersant and suspending agent such as a phosphate based-surfactant etc.

A photocurable glass paste composition comprising (A) glass fine particles, (B) a liquid photocurable compound, (C) a photopolymerization initiator, and (D) a dispersant having a polar group with affinity for glass fine particles is disclosed (Patent Document 6). The dispersant described therein includes compounds having a polar group with affinity for glass fine particles, such as a carboxyl group, a hydroxyl group or an acid ester, and polymer compounds, for example acid-containing compounds such as phosphates, acid group-containing copolymers, and hydroxyl group-containing polycarboxylates.

A composition for a dielectric layer, which comprises glass frit, a pyrolytic binder, a solvent, and a polycarboxylate type polymer compound as a dispersant is disclosed (Patent Document 7).

A paste film comprising a dispersant wherein the dispersant is one dispersant selected from a phosphate dispersant, a sulfonate dispersant and a carboxylate dispersant is disclosed (Patent Document 8).

A glass paste composition comprising (A) glass powder, (B) a binder resin, and (C) a silane coupling agent as a dispersant is disclosed (Patent Document 9).

A glass paste composition comprising (A) glass powder, (B) a binder resin, and (C) a fatty acid as a dispersant is disclosed (Patent Document 10).

A dielectric glass paste comprising one member selected from tributyl phosphate, tricresyl phosphate, triphenyl phosphate, dioctyl phthalate and dibutyl phthalate as a plasticizer and one member selected from sorbitan sesquioleate, glycerol monooleate and a phosphate as a dispersant is disclosed (Patent Document 11).

A green sheet for a dielectric layer, which comprises a fluorine compound or a silicon compound as a surfactant, is disclosed (Patent Document 12).

An inorganic particle-containing composition comprising (A) inorganic particles, (B) a binder resin, and (C) an aliphatic dicarboxylic acid diester or an aliphatic carboxylic acid ester as a plasticizer is disclosed (Patent Document 13).

A glass paste composition comprising (A) glass powder, (B) a binder resin, and (C) polypropylene glycol as a plasticizer is disclosed (Patent Document 14).

An inorganic particle-containing composition comprising (A) inorganic particles, (B) a binder resin, and (C) a monoglycerin fatty acid ester as a plasticizer is disclosed (Patent Document 15).

An inorganic particle-containing composition comprising (A) inorganic particles, (B) a binder resin, and (C) a polyglycerin fatty acid ester as both a plasticizer and a dispersant are disclosed (Patent Document 16).

However, the dispersing effect of the dispersant mentioned above is so insufficient that insufficient dispersion of glass powder easily occurs. Because of this insufficient dispersion of the glass powder, the aggregation and precipitation of the glass powder in a composition are generated, and when the composition is applied onto a support film to form a transfer sheet, it is difficult to form a film-forming material layer which is smooth and uniform in film thickness. Accordingly, there is a problem that display deficiency (uneven brightness) occurs in PDP after calcination.

The plasticizing effect of the transferability-conferring agent or the plasticizer mentioned above is so insufficient that the resulting film-forming material layer is made poor in flexibility to make it liable to transfer deficiency. To prevent transfer deficiency, the amount of the plasticizer should be increased, but when the amount of the plasticizer is large, there is a problem that calcinated residues are increased to generate bubbles easily in a dielectric layer.

When the conventional paste composition or dielectric layer-forming resin composition is used, there arises a problem that in a step of calcinating a film-forming material layer to form a dielectric layer, bubbles are generated in a softened or melted film-forming material layer to remain in the layer, thereby generating convex defect in the dielectric layer and reducing the light transmittance of the dielectric layer. The dielectric layer is required to have high surface smoothness for use as a part of a display, but the conventional paste composition has a problem that since bubbles are generated in a large amount upon softening or melting and the diameters of the bubbles are large, traces of the bubbles remain as such in the surface of the softened or melted film-forming material layer to deteriorate the surface smoothness of the dielectric layer. These problems of light transmittance and surface smoothness have been desired to be solved for the dielectric layer on a front glass substrate particularly required to have transparency and smoothness.

Patent Document 1: JP-A 9-102273

Patent Document 2: JP-A 2001-185024

Patent Document 3: JP-A 11-35780

Patent Document 4: WO 00/42622 pamphlet

Patent Document 5: JP-A 11-260254

Patent Document 6: JP-A 2000-105453

Patent Document 7: JP-A 2004-2164

Patent Document 8: Japanese Patent No. 3596530 specification

Patent Document 9: JP-A 10-310451

Patent Document 10: JP-A 11-217238

Patent Document 11: JP-A 2000-156168

Patent Document 12: JP-A 2005-191009

Patent Document 13: JP-A 2000-109341

Patent Document 14: JP-A 10-310453

Patent Document 15: JP-A 2003-96305

Patent Document 16: JP-A 2004-277704

### SUMMARY OF THE INVENTION

An object of the present invention is to provide an inorganic powder-containing resin composition excellent in an ability to disperse the inorganic powder and excellent in transferability upon formation into a sheet. Another object of the present invention is to provide an inorganic powder-containing resin composition capable of forming a dielectric layer having high light transmittance (without bubble defect) and excellent in surface smoothness. Still another object of the present invention is to provide a film-forming material layer comprising the composition, a transfer sheet, a dielectric layer, a method of producing a substrate having a dielectric layer formed thereon, a substrate having a dielectric layer formed thereon, and PDP using the substrate having a dielectric layer formed thereon.

The present inventors made extensive study for solving the problem described above, and as a result, they found that the above objects can be achieved by the following inorganic powder-containing resin composition, and the present invention was thereby arrived at.

That is, the present invention relates to an inorganic powder-containing resin composition comprising A) an inorganic powder, B) a binder resin, C) diglycerin, and D) at least one diglycerin fatty acid ester selected from the group consisting of a diglycerin fatty acid monoester, a diglycerin fatty acid diester, a diglycerin fatty acid triester, and a diglycerin fatty acid tetraester.

The present inventors have found that by adding the diglycerin C) and the diglycerin fatty acid ester D) to a composition, the composition can effectively prevent the aggregation or precipitation, due to poor dispersion, of inorganic powder and can, upon formation into a film-forming material layer, confer sufficient flexibility to significantly improve the transferability of the film-forming material layer. The inorganic powder-containing resin composition of the present invention can be used to form a film-forming material layer which is smooth and uniform in film thickness on a support film in forming a transfer sheet and can, after calcination, form a dielectric layer excellent in transparency and surface smoothness without surface defect. The reason that such significant effect is exhibited is not evident, but the following reason is conceivable.

The diglycerin has four hydroxyl groups through which it can interact strongly with inorganic powder, thereby being adsorbed preferentially onto the surface of the inorganic powder, to improve the dispersibility of the inorganic powder. Further, the diglycerin is free of a fatty acid ester group and thus hardly remains as residues after calcination. After calcination, therefore, the resulting dielectric layer is free of deterioration in surface smoothness. However, the diglycerin is free of a fatty acid ester group and is thus not able to sufficiently confer a plasticizing effect by itself. On the other hand, the diglycerin fatty acid ester has at least one fatty acid ester group and can confer a plasticizing effect. When the diglycerin fatty acid ester and the diglycerin are simultaneously used, their hydroxyl groups and fatty acid ester groups are balanced as a whole, which would lead to significant improvements in the dispersibility of the inorganic powder and in the transferability of the film-forming material layer. The diglycerin is adsorbed preferentially onto the surface of the inorganic powder, thus preventing the diglycerin fatty acid ester from being adsorbed onto the surface of the inorganic powder. Accordingly, the diglycerin fatty acid ester hardly remains as residues upon calcination, and thus bubbles hardly remain in the dielectric layer. When the diglycerin and the diglycerin fatty acid ester, each having the characteristics described above, are simultaneously used, the resulting inorganic powder-containing composition contains the inorganic powder dispersed uniformly therein and reduces residues after calcination, and thus bubbles generated upon softening or melting of the inorganic powder are made less and uniform, and the diameters of the bubbles are also reduced. Accordingly, there hardly remain traces of the bubbles, which would result in improvement of the surface smoothness of the dielectric layer.

In the present invention, the weight-average molecular weight of the binder resin is preferably 50,000 to 500,000. The binder resin is preferably (meth)acrylic resin.

In the inorganic powder-containing resin composition, it is preferable that the binder resin be contained in an amount of 5 to 50 parts by weight, and the diglycerin and the diglycerin fatty acid ester be contained in a total amount of 0.5 to 10 parts by weight, based on 100 parts by weight of the inorganic powder, and the diglycerin/diglycerin fatty acid ester ratio by weight be from 3/97 to 30/70. When the amount of the binder resin is lower than 5 parts by weight, the inorganic powder-containing resin composition is hardly formed into a flexible sheet, while when the amount is higher than 50 parts by weight, the binder resin remains in the film-forming material layer after calcination, to easily deteriorate the optical quality of the dielectric layer. When the content of the diglycerin and the diglycerin fatty acid ester is outside of the range defined above, the balance between their hydroxyl groups and fatty acid ester groups is deteriorated thereby deteriorating the dispersibility of the inorganic powder and the transferability of the film-forming material layer, making residues and bubbles liable to remain in the dielectric layer, and making traces of bubbles liable to remain in the surface of the film-forming material layer upon calcination, to render the dielectric layer prone to deterioration in surface smoothness.

The inorganic powder-containing resin composition of the present invention is useful particularly as a dielectric layer-forming material.

Further, the present invention relates to a film-forming material layer comprising the inorganic powder-containing resin composition formed in a sheet form.

Further, the present invention relates to a transfer sheet comprising at least the film-forming material layer laminated on a support film.

The dielectric layer of the present invention comprises the film-forming material layer sintered therein.

Further, the present invention relates to a method of producing a substrate having a dielectric layer formed thereon, which comprises the step of transferring a film-forming material layer of the transfer sheet onto a substrate and the step of sintering the transferred film-forming material layer at 550 to 650° C. to form a dielectric layer on the substrate, as well as a substrate having a dielectric layer formed thereon produced by the method.

Further, the present invention relates to a plasma display panel (PDP) using the substrate having a dielectric layer formed thereon.

### BEST MODE FOR CARRYING OUT THE INVENTION

The inorganic powder-containing resin composition of the present invention comprises A) an inorganic powder, B) a binder resin, C) diglycerin, and D) at least one diglycerin fatty acid ester selected from the group consisting of a diglycerin fatty acid monoester, a diglycerin fatty acid diester, a diglycerin fatty acid triester, and a diglycerin fatty acid tetraester.

The inorganic powder may be any known one and can be used without particular limitation. Specific examples include silicon oxide, titanium oxide, aluminum oxide, calcium oxide, boron oxide, zinc oxide, glass powder etc. The average particle diameter of the inorganic powder is preferably 0.1 to 10 μm.

In the present invention, glass powder is preferably used as the inorganic powder. The glass powder may be any known one and can be used without particular limitation. Examples of the powder include 1) a mixture of zinc oxide, boron oxide and silicon oxide (ZnO—B₂O₃—SiO₂ system), 2) a mixture of zinc oxide, boron oxide, silicon oxide and aluminum oxide (ZnO-B₂O₃—SiO₂—Al₂O₃ system), 3) a mixture of lead oxide, boron oxide, silicon oxide and calcium oxide (PbO—B₂O₃—SiO₂—CaO system), 4) a mixture of lead oxide, boron oxide, silicon oxide and aluminum oxide (PbO—B₂O₃—SiO₂—Al₂O₃ system), 5) a mixture of lead oxide, zinc oxide, boron oxide and silicon oxide (PbO—ZnO—B₂O₃—SiO₂ system), and 6) a mixture of lead oxide, zinc oxide, boron oxide, silicon oxide and aluminum oxide (PbO—ZnO—B₂O₃—SiO₂—Al₂O₃ system). If necessary, these inorganic powders may contain Na₂O, CaO, BaO, Bi₂O₃, SrO, TiO₂, CuO or In₂O₃. In consideration of the formation of a dielectric layer by sintering treatment, the inorganic powder is more preferably glass powder having a softening point of 400 to 650° C.

The binder resin is not particularly limited, and any known binder resin can be used, but (meth)acrylic resin is preferable.

The weight-average molecular weight of the binder resin such as (meth)acrylic resin is preferably 50,000 to 500,000, more preferably 50,000 to 300,000. When the weight-average molecular weight is lower than 50,000, the transfer sheet having a film-forming material layer thereon, prepared by applying the inorganic powder-containing resin composition onto a support film, is poor in cohesive force to reduce the strength of the transfer sheet, which is not preferable for operativeness thereafter. On the other hand, a molecular of higher than 500,000 is not preferable either because the viscosity of the inorganic powder-containing resin composition is increased to deteriorate the dispersibility of the inorganic powder.

The (meth)acrylic resin is a polymer of acrylic monomer and/or methacrylic monomer, or a mixture thereof.

Examples of the (meth)acrylic monomer include alkyl (meth)acrylates such as methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, pentyl (meth)acrylate, amyl (meth)acrylate, isoamyl (meth)acrylate, hexyl (meth)acrylate, heptyl (meth)acrylate, octyl (meth)acrylate, isooctyl (meth)acrylate, ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate and isostearyl (meth)acrylate, and aryl (meth)acrylates such as phenyl (meth)acrylate and tolyl (meth)acrylate. These monomers may be used singly or as a mixture of two or more thereof.

A monomer containing a polar group such as a carboxyl group, a hydroxyl group, an epoxy group, an amido group or an amino group may be copolymerized. By copolymerizing the polar group-containing monomer, the dispersibility of the inorganic powder can be improved. The proportion of the polar group-containing monomer compounded is preferably 0.1 to 20 mol % based on the total monomer components.

The polar group-containing monomer includes, for example, acrylic acid, methacrylic acid, 2-methyl cisacrylic acid, allylacetic acid, crotonic acid, maleic acid, methylmaleic acid, fumaric acid, methylfumaric acid, dimethylfumaric acid, itaconic acid, vinylacetic acid, 2-(meth)acryloyloxyethylsuccinic acid, 2-(meth)acryloyloxyethylphthalic acid, 2-hydroxyethyl (meth)acrylate, 2-hydroxypropyl (meth)acrylate, 3-hydroxypropyl(meth)acrylate, 2-hydroxybutyl(meth)acrylate, 3-hydroxybutyl(meth)acrylate, 4-hydroxybutyl(meth)acrylate, polyethylene glycol mono(meth)acrylate, (meth)acrylamide, glycidyl (meth)acrylate, and dimethylaminoethyl (meth)acrylate.

The (meth)acrylic resin is added in an amount of preferably 5 to 50 parts by weight, more preferably 10 to 40 parts by weight, still more preferably 15 to 30 parts by weight, relative to 100 parts by weight of the inorganic powder.

The glass transition temperature of the (meth)acrylic resin is preferably 30° C. or less, more preferably 20° C. or less. A glass transition temperature of higher than 30° C. is not preferable because the resulting transfer sheet is not flexible, thus deteriorating transferability, handling properties and the ability of the sheet to be contour along an uneven surface. The glass transition temperature of the (meth)acrylic resin can be regulated in the above range by suitably changing the compounding ratio of copolymers used.

The diglycerin fatty acid ester functions both as a dispersant by its hydroxyl groups and as a plasticizer by its ester group (—O—CO—R), and the degree of its function varies depending on the valence of the ester group. Among the diglycerin fatty acid esters, the monoester functions most strongly as a dispersant, and the function of the diglycerin fatty acid esters as a dispersant is weakened in the order of the diester, triester and tetraester, while in this order, the function of the esters as a plasticizer becomes increasingly stronger.

The number of carbon atoms in the fatty acid constituting the fatty acid ester group is 4 or more, preferably 4 to 30, more preferably 8 to 24. When the number of carbon atoms is less than 4, the function of the diglycerin fatty acid ester as a plasticizer is insufficient. When the number of carbon atoms is more than 30, residues and bubbles remain easily in the dielectric layer after calcination. The fatty acid constituting the fatty acid ester group includes, for example, saturated fatty acids such as n-butanoic acid (butyric acid), n-pentanoic acid (valeric acid), n-hexanoic acid (caproic acid), n-heptanoic acid (heptylic acid), n-octanoic acid (caprylic acid), n-nonanoic acid (pelargonic acid), n-decanoic acid (capric acid), n-dodecanoic acid (lauric acid), n-tetradecanoic acid (myristic acid), n-pentadecanoic acid (pentadecylic acid), n-hexadecanoic acid (palmitic acid), n-heptadecanoic acid (margaric acid), n-octadecanoic acid (stearic acid), n-nonadecanoic acid (tuberculostearic acid), n-eicosanoic acid (arachic acid), docosanoic acid (behenic acid), n-tetracosanoic acid (lignoceric acid), n-hexacosanoic acid (cerotic acid), n-octacosanoic acid (montanic acid) and n-triacontanoic acid (melissic acid), and unsaturated fatty acids such as crotonic acid, myristoleic acid, palmitoleic acid, oleic acid, elaidic acid, vaccenic acid, gadoleic acid, erucic acid, nervonic acid, linoleic acid, α-linolenic acid, eleostearic acid, stearidonic acid, arachidonic acid, eicosapentaenoic acid, clupanodonic acid and docosahexaenoic acid.

The diglycerin fatty acid monoester, diglycerin fatty acid diester, diglycerin fatty acid triester and diglycerin fatty acid tetraester may be used singly or in combination of two or more thereof. When the diglycerin fatty acid esters are used as a mixture of two or more thereof, the mixing ratio can be regulated appropriately in consideration of characteristics of inorganic powder, their plasticizing effect and dispersing effect. The weight ratio is established preferably such that the monoester/diester/(triester+tetraester) ratio is from 100/0/0 to 30/45/25.

The total amount of the diglycerin and the diglycerin fatty acid ester(s) added is preferably 0.5 to 10 parts by weight, more preferably 1 to 8 parts by weight, still more preferably 2 to 6 parts by weight, based on 100 parts by weight of the inorganic powder. The diglycerin/diglycerin fatty acid ester ratio by weight is preferably from 3/97 to 30/70, more preferably from 5/95 to 25/75.

When the inorganic powder-containing resin composition is applied onto a support film to form a transfer sheet having a film-forming material layer formed thereon, a solvent is added preferably to the composition such that the composition can be uniformly applied onto the support film.

The solvent is not particularly limited insofar as it is highly compatible with the inorganic powder and highly solubilizes the binder resin, the diglycerin and the diglycerin fatty acid ester. Examples of the solvent include terpineol, dihydro-α-terpineol, dihydro-α-terpinyl acetate, butyl carbitol acetate, butyl carbitol, isopropyl alcohol, benzyl alcohol, turpentine oil, diethyl ketone, methyl butyl ketone, dipropyl ketone, cyclohexanone, n-pentanol, 4-methyl-2-pentanol, cyclohexanol, diacetone alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monoethyl ether, n-butyl acetate, amyl acetate, methyl cellosolve acetate, ethyl cellosolve acetate, propylene glycol monomethyl ether acetate, ethyl-3-ethoxy propionate, 2,2,4-trimethyl-1,3-pentanediol-1-isobutyrate, and 2,2,4-trimethyl-1,3-pentanediol-3-isobutyrate. These solvents may be used singly or as a mixture of two or more thereof in an arbitrary ratio.

The amount of the solvent to be added is preferably 10 to 100 parts by weight relative to 100 parts by weight of the inorganic powder.

In addition to the components described above, various additives such as a silane coupling agent, a tackifier, a leveling agent, a stabilizer and a defoaming agent may be added to the inorganic powder-containing resin composition.

The transfer sheet of the present invention is composed of a support film and at least a film-forming material layer formed on the support film, and used in whole transfer of the film-forming material layer formed on the support film onto the surface of a substrate.

The transfer sheet is produced by applying the inorganic powder-containing resin composition onto a support film and drying it to remove the solvent to form a film-forming material layer.

The support film constituting the transfer sheet is preferably a resin film having not only heat resistance and solvent resistance but also flexibility. The support film has flexibility so that the inorganic powder-containing resin composition in a paste form can be applied onto it by such as a roll coater and the film-forming material layer can be stored and supplied in a rolled state.

The resin forming the support film includes, for example, polyethylene terephthalate, polyester, polyethylene, polypropylene, polystyrene, polyimide, polyvinyl alcohol, polyvinyl chloride and fluorine-containing resin such as polyfluoroethylene, as well as nylon and cellulose.

The thickness of the support film is not particularly limited, but is preferably about 25 to 100 μm.

The surface of the support film is subjected preferably to release treatment. The procedure of releasing the support film can thereby be facilitated in the step of transferring the film-forming material layer onto a substrate.

The method which can be used to apply the inorganic powder-containing resin composition onto the support film includes, for example, coating methods with roll coaters such as gravure, kiss and comma, die coaters such as slot and fountain, and squeeze coater, curtain coater etc., but any methods can be used insofar as a uniform film can be formed on the support film.

The thickness of the film-forming material layer is varied depending on the content of inorganic powder, the type and size of panel, etc., but is preferably 10 to 200 μm, more preferably 30 to 100 μm. When the thickness is less than 10 μm, the thickness of the finally formed dielectric layer is insufficient, thus making it difficult to achieve desired dielectric properties.

Usually, when the thickness is 30 to 100 μm, the required thickness of the dielectric layer in a large panel can be sufficiently secured. The thickness of the layer is preferably uniform, and the tolerance of the thickness is preferably within ±5%.

The transfer sheet may be provided with a protective film on the surface of the film-forming material layer. The material forming the protective film includes, for example, polyethylene terephthalate, polyester, polyethylene, polypropylene etc. The transfer sheet covered with the protective film can be stored and supplied in a rolled state. The surface of the protective film is subjected preferably to release treatment.

The method of producing a substrate having a dielectric layer formed thereon according to the present invention comprises the step of transferring a film-forming material layer of the transfer sheet onto a substrate and the step of sintering the transferred film-forming material layer at 550 to 650° C., preferably 575 to 625° C., to form a dielectric layer on the substrate.

The substrate includes ceramic or metallic substrates, and particularly when PDP is produced, a glass substrate having a suitable electrode fixed therein is used.

One example of the transfer step is shown below, but the method is not particularly limited insofar as the film-forming material layer can be transferred onto, and stuck fast to, the surface of a substrate.

After the protective film used if necessary on the transfer sheet is released, the transfer sheet is laminated on the surface of a glass substrate having an electrode fixed therein such that the surface of the film-forming material layer is abutted onto the surface of the glass substrate, and the transfer sheet is contact-bonded to the glass substrate by hot pressing with a heating roll laminator, and then the support film is released and removed from the film-forming material layer. The film-forming material layer is thereby transferred on, and stuck fast to, the surface of the glass substrate.

The transfer conditions are selected such that for example, the surface temperature of the laminator is 25 to 100° C., the linear pressure of the roll is 0.5 to 15 kg/cm, the rate of travel is 0.1 to 5 m/min., but the transfer conditions are not limited thereto. The glass substrate may be pre-heated, and the preheating temperature is about 50 to 100° C.

One example of the step of sintering the film-forming material layer is shown below, but the method is not particularly limited insofar as the dielectric layer can be formed on the substrate by sintering the film-forming material layer at 550 to 650° C.

The glass substrate having the film-forming material layer formed thereon is placed in an atmosphere at a high temperature of 550 to 650° C., whereby the organic materials (binder resin, diglycerin, diglycerin fatty acid ester, residual solvent, various additives etc.) in the film-forming material layer are decomposed and removed, and the inorganic powder (glass powder) is melted and sintered. A dielectric layer consisting of an inorganic sintered product (sintered glass) is formed on the glass substrate, to form a substrate having a dielectric layer formed thereon.

The thickness of the dielectric layer, though being varied depending on the thickness of the film-forming material layer used, is about 15 to 50 μm.

Thereafter, the substrate having a dielectric layer formed thereon is subjected to various steps thereby forming a front glass substrate or a back glass substrate. Then, the front or back glass substrate is stuck in a panelizing step and then subjected to various steps to produce PDP.

The substrate having a dielectric layer formed thereon according to the present invention is free of residual bubbles or cracks in the dielectric layer, has the high surface smoothness of the dielectric layer and is excellent in optical qualities such as light transmittance. Accordingly, the substrate is preferably used in particular as a front glass substrate of PDP.

### EXAMPLES

Hereinafter, the present invention is described in more detail by reference to the Examples, but the present invention is not limited thereto.

### (Measurement of Weight-Average Molecular Weight)

The weight-average molecular weight of the prepared (meth)acrylic resin was determined by GPC (gel permeation chromatography) and converted using polystyrene standards. GPC unit: HLC-8220 GPC manufactured by Tosoh Corporation Columns: TSK gel Super HZM-H, H-RC and HZ-H columns manufactured by Tosoh Corporation

Flow rate: 0.6 ml/min.

### Concentration: 0.2 wt %

Injection volume: 20 μl
Column temperature: 40° C.

### Eluate: THF

### (Measurement of Glass Transition Point and Softening Point)

The transition point and softening point of glass used were determined by DTA (differential thermal analysis). The transition point is a temperature in a shoulder of a first endothermic portion of a DTA curve, and the softening point is a temperature in a tail of a second endothermic portion of the DTA curve.

Unit: TG/DTA220 (manufactured by S.I.I. Nanotechnologies)
Rate of temperature increase: 20° C./min.

### (Measurement of the Viscosity of the Glass-Containing Resin Composition and Evaluation of its Dispersibility)

The viscosity of the prepared glass-containing resin composition was measured with a BH-type viscometer. It is known that when the glass-containing resin composition is excellent in dispersibility, the viscosity of the composition is reduced, and thus the viscosity can serve as an indictor of dispersibility. The viscosity of the glass-containing resin composition is preferably 20 Pa·s or less.

Apparatus: BH-type viscometer (manufactured by Toki Sangyo Co., Ltd.).
Measurement conditions: Rotor No. 6, 20 rpm, 23° C.

### (Evaluation of Transferability)

The protective film was released from the transfer sheet, and then the surface of the film-forming material layer of the transfer sheet was abutted and laminated on the surface (bus electrode-fixed surface) of a glass substrate for panel (PD200 manufactured by Asahi Glass Company) and contact-bonded to the glass substrate by hot pressing with a heating roll laminator. In this contact-bonding, the surface temperature of the heating roll was 75° C., the linear pressure of the roll was 1 kg/cm, and the speed of travel of the roll was 1 m/min. After the hot contact-bonding treatment, the support film was released and removed from the film-forming material layer. Then, the state of the film-forming material layer transferred onto the surface of the glass substrate was observed with the naked eye and evaluated under the following criteria:

◯: The film-forming material layer is firmly attached, without cracking or chipping, to the surface of the glass substrate.
x: Not transferable.

### (Evaluation of the Appearance of the Dielectric Layer)

The bubble defect and surface smoothness in appearance of the resulting dielectric layer were observed with the naked eye and evaluated under the following criteria:

With respect to Bubble Defect

◯: No bubble defect.

Δ: Slight bubble defect (1 to 2 bubbles/1250 mm²).

x: Much bubble defect (3 or more bubbles/1250 mm²).

### With Respect to Surface Smoothness

◯: Smooth.

Δ: Nearly smooth but with a slightly distorted surface reflection image of a fluorescent lamp.

x: Unevenness can be confirmed with the naked eye.

### Example 1

### Preparation of (Meth)Acrylic Resin

A four-necked flask equipped with a stirring blade, a thermometer, a nitrogen gas inlet tube, a condenser and a dropping funnel was charged with butyl methacrylate, benzoyl peroxide as a polymerization initiator, and toluene, and then a nitrogen gas was introduced into the mixture under gentle stirring, and the mixture was subjected to polymerization reaction for about 8 hours while the temperature of the solution in the flask was kept at about 85° C., to prepare a methacrylic resin solution having a solids content of 50% by weight. The weight-average molecular weight of the resulting methacrylic resin was 100,000.

### [Preparation of an Inorganic Powder-Containing Resin Composition]

100 parts by weight of PbO—B₂O₃—SiO₂—ZnO—Al₂O₃-based glass powder (glass transition point, 420° C.; softening point, 480° C.), 20 parts by weight of the above methacrylic resin, 4 parts by weight of a mixture of diglycerin and diglycerin fatty acid esters (diglycerin/monooleate/dioleate/trioleate=7/35/39/19 (weight ratio)) serving as both a dispersant and a plasticizer, and 36 parts by weight of α-terpineol and 4 parts by weight of butyl carbitol acetate both serving as solvent, were compounded, mixed and dispersed with a dispersing machine to prepare a glass-containing resin composition in a paste form. The viscosity of the resulting glass-containing resin composition was 16.5 Pa·s

### [Preparation of a Transfer Sheet]

A support film obtained by treating a polyethylene terephthalate (PET) film with a releasing agent was coated by a roll coater with the glass-containing resin composition prepared above, and the resulting coating film was dried at 150° C. for 3 minutes to remove the solvent, thereby forming a film-forming material layer (thickness: 72 μm). Thereafter, the film-forming material layer was covered with a protective film (PET subjected to release treatment with silicone) and then rolled to prepare a transfer sheet.

[Preparation of a Glass Substrate Having a Dielectric Layer formed Thereon]

The protective film was released from the transfer sheet, and the surface of the film-forming material layer of the transfer sheet was abutted and laminated on the surface (bus electrode-fixed surface) of a glass substrate for panel (PD200 manufactured by Asahi Glass Company) and contact-bonded to the glass substrate with a heating roll laminator. In this contact-bonding, the surface temperature of the heating roll was 75° C., the linear pressure of the roll was 1 kg/cm, and the speed of travel of the roll was 1 m/min. After the hot contact-bonding treatment, the support film was released and removed from the film-forming material layer. The glass substrate having the film-forming material layer transferred thereon was placed in a calcinating furnace, and the temperature in the furnace was increased from room temperature to 600° C. at an increasing rate of 20° C./min. and then maintained in an atmosphere at a temperature of 600° C. for 60 minutes, thereby forming a dielectric layer (thickness: 32 μm) on the surface of the glass substrate, to produce a glass substrate having a dielectric layer formed thereon.

### Example 2

A glass-containing resin composition was prepared in the same manner as in Example 1 except that 4 parts by weight of a mixture of diglycerin and diglycerin fatty acid esters (diglycerin/monooleate/dioleate/trioleate=21/30/33/16 (weight ratio)) serving as both a dispersant and a plasticizer was used. The viscosity of the resulting glass-containing resin composition was 19 Pa·s. A glass substrate having a dielectric layer formed thereon (thickness of the dielectric layer: 32 μm) was prepared in the same manner as in Example 1 except that the above glass-containing resin composition was used.

### Example 3

A glass-containing resin composition was prepared in the same manner as in Example 1 except that 4 parts by weight of a mixture of diglycerin and diglycerin fatty acid esters (diglycerin/monooleate=10/90 (weight ratio)) serving as both a dispersant and a plasticizer was used. The viscosity of the resulting glass-containing resin composition was 17 Pa·s. A glass substrate having a dielectric layer formed thereon (thickness of the dielectric layer: 32 μm) was prepared in the same manner as in Example 1 except that the above glass-containing resin composition was used.

### Comparative Example 1

A glass-containing resin composition was prepared in the same manner as in Example 1 except that the mixture of diglycerin and diglycerin fatty acid esters was not used. The viscosity of the resulting glass-containing resin composition was 17.5 Pa·s. Glass powder aggregates were confirmed with the naked eye. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

### Comparative Example 2

A glass-containing resin composition was prepared in the same manner as in Example 1 except that 4 parts by weight of a silane coupling agent (hexyl trimethoxysilane, KBM3063, manufactured by Shin-Etsu Chemical Co., Ltd.) was used as a dispersant and a plasticizer. The viscosity of the resulting glass-containing resin composition was 7.5 Pa·s. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

### Comparative Example 3

A glass-containing resin composition was prepared in the same manner as in Example 1 except that 4 parts by weight of a polycarboxylic acid (Florene G manufactured by Kyoeisha Chemical Co., Ltd.) was used as a dispersant and a plasticizer. The viscosity of the resulting glass-containing resin composition was 53 Pa·s. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

### Comparative Example 4

A glass-containing resin composition was prepared in the same manner as in Example 1 except that 4 parts by weight of sorbitan monooleate (Poem 0-80V manufactured by Riken Vitamin Co., Ltd.) was used as a dispersant and a plasticizer. The viscosity of the resulting glass-containing resin composition was 18 Pa·s. A glass substrate having a dielectric layer formed thereon (thickness of the dielectric layer: 32 μm) was prepared in the same manner as in Example 1 except that the above glass-containing resin composition was used.

### Comparative Example 5

A glass-containing resin composition was prepared in the same manner as in Example 1 except that 4 parts by weight of propyleneglycol monooleate (Rikemarl P0-100 manufactured by Riken Vitamin Co., Ltd.) was used as a dispersant and a plasticizer. The viscosity of the resulting glass-containing resin composition was 7.5 Pa·s. A glass substrate having a dielectric layer formed thereon (thickness of the dielectric layer: 32 μm) was prepared in the same manner as in Example 1 except that the above glass-containing resin composition was used.

### Comparative Example 6

A glass-containing resin composition was prepared in the same manner as in Example 1 except that 4 parts by weight of bis (2-ethylhexyl)adipate (DOA manufactured by Taoka Chemical Co., Ltd.) was used as a dispersant and a plasticizer. The viscosity of the resulting glass-containing resin composition was 19 Pa·s. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

### Comparative Example 7

A glass-containing resin composition was prepared in the same manner as in Example 1 except that 4 parts by weight of diglycerin monooleate (Rikemarl DO-100 manufactured by Riken Vitamin Co., Ltd.) was used as a dispersant and a plasticizer.

The viscosity of the resulting glass-containing resin composition was 15.5 Pa·s. A glass substrate having a dielectric layer formed thereon (thickness of the dielectric layer: 32 μm) was prepared in the same manner as in Example 1 except that the above glass-containing resin composition was used.

### Comparative Example 8

A glass-containing resin composition was prepared in the same manner as in Example 1 except that 4 parts by weight of stearic acid was used as a dispersant and a plasticizer. The viscosity of the resulting glass-containing resin composition was 100 Pa·s. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

### Comparative Example 9

A glass-containing resin composition was prepared in the same manner as in Example 1 except that 4 parts by weight of polypropyleneglycol was used as a dispersant and a plasticizer. The viscosity of the resulting glass-containing resin composition was 14.5 Pa·s. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

### Comparative Example 10

A glass-containing resin composition was prepared in the same manner as in Example 1 except that 4 parts by weight of monoglycerinacetyl monooleate (Poem G-038 manufactured by Riken Vitamin Co., Ltd.) was used as a dispersant and a plasticizer. The viscosity of the resulting glass-containing resin composition was 8 Pa·s. A glass substrate having a dielectric layer formed thereon (thickness of the dielectric layer: 32 μm) was prepared in the same manner as in Example 1 except that the above glass-containing resin composition was used.

### Comparative Example 11

A glass-containing resin composition was prepared in the same manner as in Example 1 except that 4 parts by weight of diglycerin was used as a dispersant and a plasticizer. The viscosity of the resulting glass-containing resin composition was 74.5 Pa·s. Thereafter, the glass-containing resin composition was used to prepare a transfer sheet in the same manner as in Example 1, but because of the insufficient plasticity of a film-forming material layer, the film-forming material layer could not be transferred onto the surface of a glass substrate.

TABLE 1

| | Dispersant, | Viscosity | | Bubble | Surface |
|---|---|---|---|---|---|
| | plasticizer | (Pa · s) | Transferability | defect | smoothness |
| Example 1 | diglycerin + | 16.5 | ∘ | ∘ | ∘ |
| | diglycerin oleate | | | | |
| Example 2 | diglycerin + | 19 | ∘ | ∘ | ∘ |
| | diglycerin oleate | | | | |
| Example 3 | diglycerin + | 17 | ∘ | ∘ | ∘ |
| | diglycerin oleate | | | | |
| Comparative | none | 17.5 | x | — | — |
| Example 1 | | | | | |
| Comparative | silane coupling | 7.5 | x | — | — |
| Example 2 | agent | | | | |
| Comparative | polycarboxylic | 53 | x | — | — |
| Example 3 | acid | | | | |
| Comparative | sorbitan | 18 | ∘ | x | x |
| Example 4 | monooleate | | | | |
| Comparative | propylene glycol | 7.5 | ∘ | x | x |
| Example 5 | monooleate | | | | |
| Comparative | bis(2-ethylhexyl) | 19 | x | — | — |
| Example 6 | adipate | | | | |
| Comparative | diglycerin | 15.5 | ∘ | ∘ | x |
| Example 7 | monooleate | | | | |
| Comparative | stearic acid | 100 | x | — | — |
| Example 8 | | | | | |
| Comparative | polypropylene | 14.5 | x | — | — |
| Example 9 | glycol | | | | |
| Comparative | monoglycerin | 8 | ∘ | x | x |
| Example 10 | acetyl monooleate | | | | |
| Comparative | diglycerin | 74.5 | x | — | — |
| Example 11 | | | | | |

From the results in Table 1, it can be seen that an inorganic powder-containing resin composition excellent in an ability to disperse the inorganic powder and excellent in transferability upon formation into a sheet can be obtained by simultaneously using the glycerin and diglycerin fatty acid esters both serving as a dispersant and a plasticizer. Further, the inorganic powder-containing resin composition of the present invention can be used to form a dielectric layer free of bubble defect and excellent in surface smoothness.

1. An inorganic powder-containing resin composition comprising A) inorganic powder, B) a binder resin, C) diglycerin, and D) at least one diglycerin fatty acid ester selected from the group consisting of a diglycerin fatty acid monoester, a diglycerin fatty acid diester, a diglycerin fatty acid triester, and a diglycerin fatty acid tetraester.

2. The inorganic powder-containing resin composition according to claim 1, wherein the weight-average molecular weight of the binder resin is 50,000 to 500,000.

3. The inorganic powder-containing resin composition according to claim 1, wherein the binder resin is (meth)acrylic resin.

4. The inorganic powder-containing resin composition according to claim 1, wherein the binder resin is contained in an amount of 5 to 50 parts by weight, and the diglycerin and the diglycerin fatty acid ester are contained in a total amount of 0.5 to 10 parts by weight, based on 100 parts by weight of the inorganic powder, and the diglycerin/diglycerin fatty acid ester ratio by weight is from 3/97 to 30/70.

5. The inorganic powder-containing resin composition according to claim 1, which is used as a material forming a dielectric layer.

6. A film-forming material layer comprising the inorganic powder-containing resin composition according to claim 1 formed in a sheet form.

7. A transfer sheet comprising at least the film-forming material layer according to claim 6 laminated on a support film.

8. A dielectric layer comprising the film-forming material layer according to claim 6 sintered therein.

9. A method of producing a substrate having a dielectric layer formed thereon, comprising the step of transferring the film-forming material layer of the transfer sheet according to claim 7 onto a substrate and the step of sintering the transferred film-forming material layer at 550 to 650° C. to form a dielectric layer on the substrate.

10. A substrate having a dielectric layer formed thereon, which is produced according to the method of claim 9.

11. A plasma display panel using the substrate having a dielectric layer formed thereon according to claim 10.

12. The inorganic powder-containing resin composition according to claim 1, wherein a fatty acid constituting a fatty acid ester group of the at least one diglycerin fatty acid ester contains 4 to 30 carbon atoms.

13. The inorganic powder-containing resin composition according to claim 1, wherein the weight ratio distribution of diglycerin fatty acid ester(s) in the at least one diglycerin fatty acid ester is from 100/0/0 to 30/45/25 in terms of diglycerin fatty acid monoester/diglycerin fatty acid diester/(diglycerin fatty acid triester+diglycerin fatty acid tetraester).

14. The inorganic powder-containing resin composition according to claim 1, wherein the binder resin comprises 0.1 to 20 mole percent of a monomer containing a polar group.
